(19) United States
(12) Patent Application Publication
(10) Pub. No.: US 2012/0210889 A1
(43) Pub. Date: Aug. 23, 2012

(54) ARRANGEMENT INSERTED INTO A COMPACTING ASSEMBLY USED IN A MANUAL GARLIC PRESS

(76) Inventor: Edson Troccoli, Santana de Parnaiba - SP (BR)

(21) Appl. No.: 13/212,956

(22) Filed: Aug. 18, 2011

(30) Foreign Application Priority Data
Feb. 18, 2009 (BR) MU 8900170-2
Feb. 18, 2009 (BR) PCT/BR2010/000025

(51) Int. Cl. A47J 19/06; B30B 9/06

(52) U.S. Cl. 100/110

(57) ABSTRACT

An arrangement inserted into a compacting device applied in a manual garlic masher is disclosed, more specifically, a garlic masher equipped with a compacting device that allows for total pressure to be applied to garlic bulbs contained inside a receptacle (3) by means of pressure through a plate (4) having trapezoid protuberances (5) towards holes (6) existing on the base (3a) of the receptacle (3). The perfect fit of said protuberances (5) in the holes (6), as well as the sectional format of each one of these elements allows for the total crushing and mashing of garlic bulbs, and subsequently the total elimination of the garlic mass, thus making use of the full relevant spice.

### CROSS-REFERENCE TO RELATED APPLICATION

This application claims the benefit of the priority filing date of international application no. PCT/BR2010/000025, and Brazilian application no. MU 8900170-2 filed on Feb. 18, 2009.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to a new arrangement inserted in a compacting device applied in a manual garlic masher. Specifically, it is a compacting set that presses garlic bulbs against the base of a manual masher receptacle, completely mashing and crushing the garlic bulbs, resulting in the total elimination of the garlic mass to efficiently produce garlic spice. This compacting device is comprised of multiple “male” protuberances in preferably “Y”-shaped sections, that fit perfectly in multiple holes in peripheral formats identical to the protuberances. These holes are located on the flat base of the manual garlic masher, allowing for all crushed garlic to be eliminated outwards by means of pressure between the parts.

Several models of manual garlic mashers are known. The simplest of them is the garlic mortar, which generally has a deep and conical cavity and a cylindrical club (pestle) with an arched deformity at one end. Thus, the user inserts garlic bulbs in the mortar and crushes them through pressure applied against the bottom of the cavity by pressing the arched end of the pestle. This crushes the garlic bulbs, producing garlic paste.

However, said garlic mortar has drawbacks. For example, strong pressure must be applied against the garlic bulbs in order to produce garlic paste. This may be impractical for some users, such as the elderly or persons with special needs.

Another drawback is that the cavity and pestle of said garlic mortar must be cleaned, which is time-consuming.

Also known is a metal, aluminum or stainless steel-based garlic masher, formed by a pair of stems that can be articulated, juxtaposed and connected by a crossing axle. The lower stem has a free end comprised of a receptacle, of which the flat base has multiple holes. The upper stem has a forcer comprised of an orthogonal projection. Its free end consists of a plate having a format identical to that of the peripheral internal contour of the receptacle. Said forcer is axially laid out towards the lower stem. Thus, when the upper stem is pressed against the lower stem, the plate of the forcer presses the garlic bulbs against the flat internal base of the receptacle, allowing the mashed garlic to migrate through the holes of the receptacle's base.

The drawback of this model lies in the fact that the plate of the forcer does not allow the bulbs to be totally crushed, frequently leaving garlic residue inside the receptacle's base after pressure is applied. This means that the user must either manually slice the garlic residue or throw it out as waste.

Another drawback lies in the fact that garlic residue is left inside this conventional model, and is difficult to remove when cleaning.

The aforesaid drawbacks are resolved in the present invention, which consists of a new constructive arrangement inserted in a compacting device applied in the forcer of a manual garlic masher. More specifically, it is a garlic compacting system that completely crushes and mashes garlic bulbs, and it is an arrangement consisting of a newly formatted compacting device in which pressure exerted by a pestle and a base results in a complete elimination of the garlic mass.

The new compacting device is basically comprised of two conventional parts. One part is an activating stem equipped with an articulated pressure forcer having a pressuring plate with a lower surface comprised of multiple “male” protuberances in preferably “Y”-shaped sections and evenly distributed. The other supplementary part comprises a support stem that is parallel to the activating stem. The end of the support stem has a receptacle whose internal perimeter corresponds to the configuration of the pressuring plate of the activating stem, and also has a means for articulating the activating stem. The base of said receptacle is flat and has multiple “female”-type holes, of which the cavity has an internal peripheral format identical to the external perimeters of each “Y”-shaped protuberance of the lower surface of the pressuring plate. This “Y”-shaped supplementary format allows for the perfect coupling of protuberances into the holes, and further directs the crushed matter outside the receptacle.

Thus, when the upper stem is pressed against the support stem through manual force applied by the user, the forcer descends into the interior of the receptacle, causing the multiple protuberances of the pressuring plates to crush the garlic bulbs and eliminate the crushed paste through the “female” holes of the receptacle.

The major advantage of the new garlic masher is that the coupling of the compacting device totally eliminates and crushes garlic bulbs, thereby making full use of the spice.

Another advantage is that full elimination of the crushed garlic though the new device makes it easier to clean the manual garlic crusher for subsequent use.

### SUMMARY

The present invention relates to a new arrangement inserted in a compacting device applied in a manual garlic masher. Specifically, it is a compacting set that presses garlic bulbs against the base of a manual masher receptacle, completely mashing and crushing the garlic bulbs, resulting in the total elimination of the garlic mass to efficiently produce garlic spice. This compacting device is comprised of multiple “male” protuberances in preferably “Y”-shaped sections, that fit perfectly in multiple holes in peripheral formats identical to the protuberances. These holes are located on the flat base of the manual garlic masher, allowing for all crushed garlic to be eliminated outwards by means of pressure between the parts.

### DRAWINGS

FIG. 1 shows an open perspective view of elements comprising the innovative garlic masher;

FIG. 2 shows an assembled and closed perspective view of the masher;

FIGS. 3 and 4 illustrate a lower perspective view and its respective details.

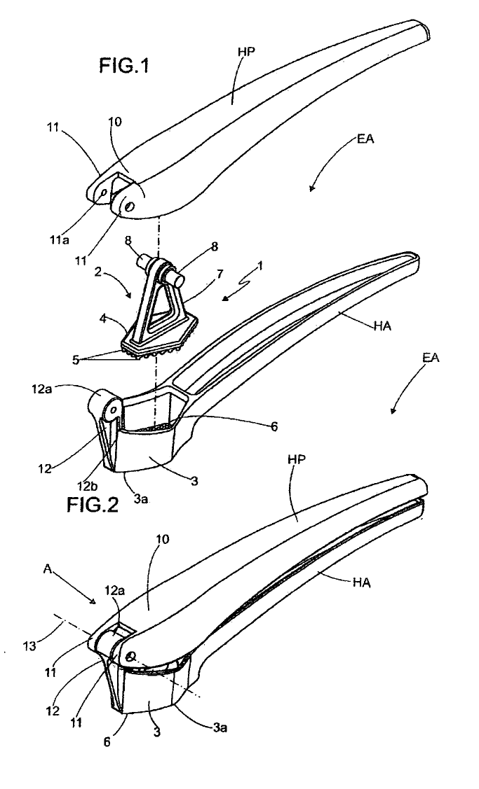

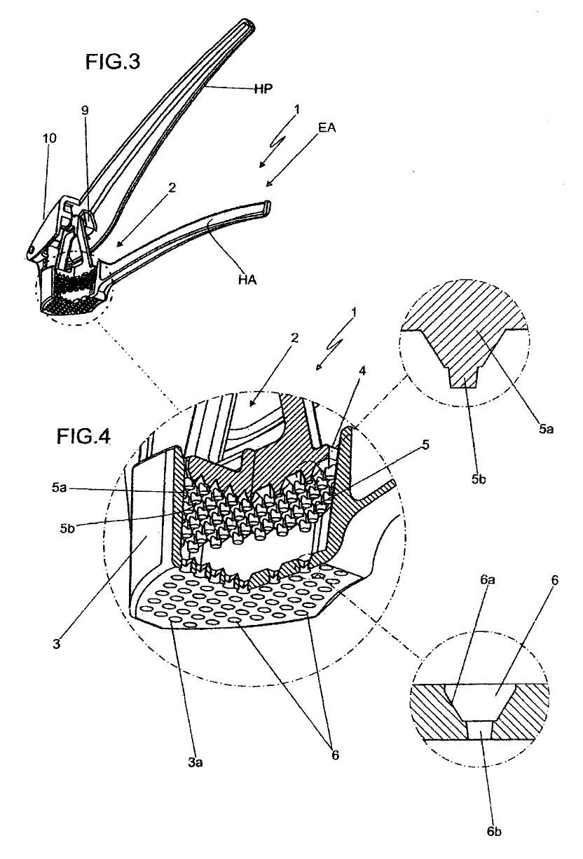

### DETAILED DESCRIPTION

Referring to the illustrated drawings, the inventive model of the Device relates to a new arrangement inserted in a compacting device applied in a manual garlic masher. More specifically; the invention is a garlic masher (EA) with a compacting system (1), having two basic parts, one of which is the pressure stem (HP) with an articulated forcer (2), and one support stem (HA) having a receptacle (3) that can receive and allow for the movements of the forcer (2); said stems (HP) and (HA) are articulated in themselves (A), especially in the stretch related to the border of the receptacle (3), and when the referred stems are pressed against each other, the garlic bulbs contained in the receptacle are mashed and crushed, thus resulting in a garlic paste.

The innovating compacting device (1) allows for the lower surface of the pressuring plate (4) of the forcer (2) to be filled with multiple and identical “male” protuberances (5), with a preferably “Y”-shaped section, and each protuberance (5) has an inverted graded cone (5a), and from its thinner diameter, in a continuous radius, a short cylindrical projection (5b) is developed.

The receptacle (3) is configured with an internal perimeter of the same size as the external perimeter of the pressuring plate (4), and is closed from below by a flat base (3a) with multiple holes (6), distributed evenly and corresponding to the protuberances (5) of the forcer (2). Each of said holes (6) has a “Y”-shaped section comprising a conical sector (6a), and from its thinner diameter a cylindrical part (6b) develops in a continuous radius to form a receptacle by fitting the sectors (5a) and (5b) the referred protuberances (5). This results in the total coupling of male protuberances (5) in female holes (6), which allows for the full crushing of garlic bulbs.

In a preferred embodiment, the referred forcer (2) is comprised of a support (7) with a preferably trapezoid format, and two cylindrical axles (8) are applied in the free upper vertex, with opposed diameters, which are fitted in corresponding internal cores (9) intended in the head stretch (10) of the pressure stem (HP). Said head (10) also provides for a reentrance that configures a part of parallel tabs (11) with thin holes (11a) that are a part of the articulation (A) between the parts of the garlic masher (EA). The support base (7) is integrated from the upper surface of the pressuring plate (4).

The receptacle (3) provides that, from its border, in opposed diameter in comparison to the support stem (HA), there will be an elongated sector (12) with a cylindrical end stretch (12a) trespassed by a thin hole (12b). The referred articulation is assembled by a small axle (13).

Thus, when the pressure stem (HP) and support stem (HA) are pressed against each other, the forcer (2) slides to the interior of the receptacle (3) until the protuberances (5) are perfectly coupled to the holes (6), resulting in the full crushing of garlic bulbs inside the receptacle.

Although the preferred preparation of this device is described, any changes could be done within the scope of the model, fitting perfectly into the criteria defining it, meaning: the combination of elements already known in a new form or layout, resulting in improved operation or manufacture.

What is claimed:

1. A new arrangement inserted in a compacting device applied in a manual garlic masher, more specifically, a garlic masher (EA) with a compacting system (1), having two basic parts, one of which is a pressure stem (HP) with an articulated forcer (2), and one support stem (HA) having a receptacle (3) that can receive and allow for movement of the forcer (2); said stems (HP) and (HA) are articulated in themselves (A), especially in the stretch related to the border of the receptacle (3), and when the referred stems are pressed against each other, there is the mashing and crushing of bulbs of garlic contained in the receptacle, thus resulting in a garlic paste; characterized in that
the innovating compacting device (1) allows for the lower surface of the pressuring plate (4) of the forcer (2) to be filled with multiple and identical “male” protuberances (5), with a preferably “Y”-shaped section, distributed evenly, and each protuberance (5) has an inverted graded cone (5a), and from its thinner diameter, in a continuous radius, a short cylindrical projection (5b) is developed;
the receptacle (3) is configured with an internal perimeter of the same size of the external perimeter of the pressuring plate (4), and is closed from below by a flat base (3a) with multiple holes (6), distributed evenly and corresponding to the protuberances (5) of the forcer (2); and
each of said holes (6) has a “Y”-shaped section comprising a conical sector (6a), and from its thinner diameter a cylindrical part (6b) develops in continuous radius by fitting the sectors (5a) and (5b) the referred protuberances (5) in order to receive.

2. The new arrangement according to claim 1 and in a preferential configuration, characterized in that,
the forcer (2) has a support (7) of preferably trapezoid format, and two cylindrical axles (8) are applied in the free upper vertex with opposed diameters, which are fitted in corresponding internal cores (9) intended in the head stretch (10) of the pressure stem (HP); and
the support base (7) is integrated to the upper surface of the pressure plate (4).
